(19) United States
(12) Patent Application Publication
(10) Pub. No.: US 2025/0147325 A1
(43) Pub. Date: May 8, 2025

(54) STRAP ADJUSTMENT APPARATUS OF HEAD-MOUNTED ELECTRONIC DEVICE AND HEAD-MOUNTED ELECTRONIC DEVICE

(71) Applicant: Beijing Zitiao Network Technology Co., Ltd., Beijing (CN)

(72) Inventors: An ZHANG, Beijing (CN); Guanghui LIU, Beijing (CN); Yi LAI, Beijing (CN); Wei JIA, Beijing (CN)

(21) Appl. No.: 18/837,710

(22) PCT Filed: Mar. 6, 2023
(86) PCT No.: PCT/CN2023/079829

§ 371 Date: Aug. 12, 2024

(30) Foreign Application Priority Data
Mar. 17, 2022 (CN) 202210266612.X

(51) Int. Cl. G02B 27/01

(52) U.S. Cl. CPC G02B 27/0176; G02B 2027/0154

(57) ABSTRACT

A strap adjustment apparatus of a head-mounted electronic device, and a head-mounted electronic device. The strap adjustment apparatus comprises: a strap assembly wherein the strap assembly comprises a strap and a driving gear, the strap comprises a rack portion, and the driving gear is meshed with the rack portion to drive the strap to move by means of the rotation of the driving gear; a knob assembly, wherein the knob assembly comprises a knob and a self-locking mechanism, and the self-locking mechanism cooperates with the knob to limit the rotation direction of the knob; and an elastic reset element, wherein the elastic reset element and the knob are linked to each other so as to switch between a compressed state and a reset state. Therefore, the length of the strap assembly can be adjusted, and the strap adjustment apparatus is matched with a wearer.

The present application claims the priority right of the Chinese patent application filed by BEIJING ZITIAO NETWORK TECHNOLOGY CO., LTD. on Mar. 17, 2022, having the application No. 202210266612.X and entitled “STRAP ADJUSTMENT APPARATUS OF HEAD-MOUNTED ELECTRONIC DEVICE AND HEAD-MOUNTED ELECTRONIC DEVICE”.

### FIELD

The present disclosure relates to the field of head-mounted devices, and more specifically to a strap adjustment apparatus of a head-mounted electronic device and a head-mounted electronic device.

### BACKGROUND

A strap adjustment apparatus now is applied to fixate a head-mounted electronic device to a head of a wearer. Since the wearers have different head circumferences, it is difficult to adapt the head-mounted electronic device to the wearers, which further affects the user experience.

In the related art, a strap of the head-mounted electronic device does not have an adjustment function and has a fixed size. This affects the wearing experience of the wearers. Although some of the head-mounted electronic devices have adjustable straps, the response speed of the straps is slow during the adjustment and the operation is quite inconvenient. As a result, the usage experience of the wearer for the head-mounted electronic device is severely affected.

### SUMMARY

The present disclosure is intended to to at least solve one of the existing technical problems in the art.

For this, the present disclosure proposes a strap adjustment apparatus of a head-mounted electronic device.

The strap adjustment apparatus of the head-mounted electronic device in accordance with the present disclosure comprises: a strap assembly including a strap and a driving gear, wherein the strap includes a rack portion and the driving gear is in mesh with the rack portion to actuate the strap to move through rotation of the driving gear; a knob assembly including a knob and a self-locking mechanism, wherein the self-locking mechanism cooperates with the knob to limit a rotational direction of the knob; the knob is switchable between a fitting position and a release position with respect to the strap assembly; the knob, at the fitting position, is in transmission fit with the driving gear to actuate the driving gear to rotate through rotation of the knob, thereby driving the strap to move; and the knob, at the release position, is unmated from the driving gear and could not actuate the driving gear to rotate, and the driving gear is enabled to rotate through mesh between the rack portion and the driving gear when the strap is pulled; an elastic reset element, which is mutually linked to the knob to switch between a compressed state and a reset state; wherein when moving to the release position, the knob links to the elastic reset element to compress and deform the elastic reset element to the compressed state; when the elastic reset element is restored from deformation to the reset state, the knob is linked to move to the fitting position.

Therefore, the transmission fit between the knob assembly and the driving gear may actuate movement of the strap, to adjust the fitting position for the driving gear and the strap. As a result, the length of the strap assembly is adjusted to fit the strap adjustment apparatus to the wearer. During the adjustment, the linkage between the elastic reset element and the knob may adjust the position of the knob, to satisfy the using needs of the user for fastening or releasing the strap assembly. This adjustment approach is simple and highly reliable.

The present disclosure also proposes a head-mounted electronic device comprising the above strap adjustment apparatus.

Additional aspects and advantages of the present disclosure will be partly described in the following description, and part of them may become apparent through the above description or be made known through practice of the present disclosure.

### BRIEF DESCRIPTION OF THE DRAWINGS

FIG. 1 illustrates a structural diagram of a strap adjustment apparatus according to one embodiment of the present disclosure;

FIG. 2 illustrates an exploded diagram of the strap adjustment apparatus according to a first embodiment of the present disclosure;

FIG. 3 illustrates a sectional view I of the strap adjustment apparatus according to a first embodiment of the present disclosure;

FIG. 4 illustrates a sectional view II of the strap adjustment apparatus according to a first embodiment of the present disclosure;

FIG. 5 illustrates an exploded diagram of the strap adjustment apparatus according to a second embodiment of the present disclosure;

FIG. 6 illustrates a sectional view I of the strap adjustment apparatus according to a second embodiment of the present disclosure;

FIG. 7 illustrates a sectional view II of the strap adjustment apparatus according to a second embodiment of the present disclosure;

FIG. 8 illustrates an exploded diagram of the strap adjustment apparatus according to a third embodiment of the present disclosure;

FIG. 9 illustrates a sectional view I of the strap adjustment apparatus according to a third embodiment of the present disclosure;

FIG. 10 illustrates a sectional view II of the strap adjustment apparatus according to a third embodiment of the present disclosure;

FIG. 11 illustrates a structural diagram I of the elastic reset element according to embodiments of the present disclosure;

FIG. 12 illustrates a structural diagram II of the elastic reset element according to embodiments of the present disclosure;

FIG. 13 illustrates a structural diagram of the driving gear according to embodiments of the present disclosure.

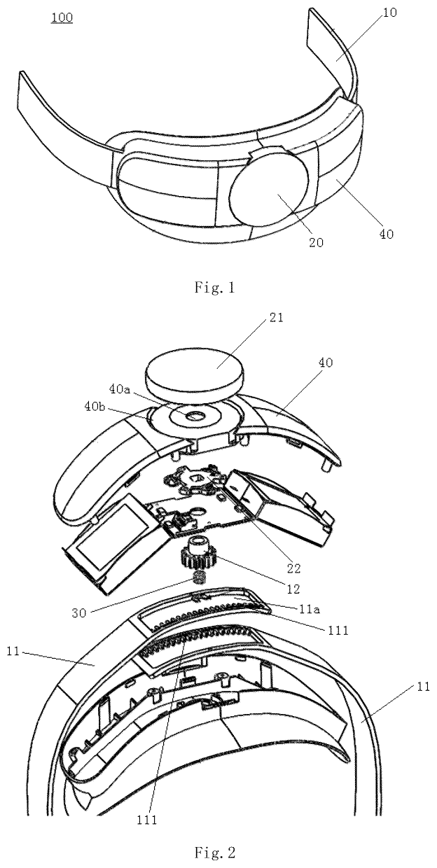

### DETAILED DESCRIPTION OF EMBODIMENTS

Embodiments of the present disclosure are to be described in details below and examples of the embodiments are demonstrated in the drawings, where same or similar reference signs indicate same or similar elements or elements with same or similar functions throughout the description. The embodiments described below with reference to the drawings are exemplary and intended to explain the present application, rather than restricting it.

The strap adjustment apparatus 100 in accordance with embodiments of the present disclosure is applied to a head-mounted electronic device. The strap adjustment apparatus fixes the head-mounted electronic device to a head of a wearer. On account of different head circumferences of the wearers, the strap adjustment apparatus 100 matches the head-mounted electronic device with a head size (head circumference) of the wearer to promote universality of the head-mounted electronic device.

The strap adjustment apparatus 100 of the head-mounted electronic device in accordance with embodiments of the present disclosure includes: a strap assembly 10, a knob assembly 20 and an elastic reset element 30.

The strap assembly 10 includes a strap 11 and a driving gear 12; the strap 11 consists of a rack portion 111, which is in mesh with the driving gear 12 to drive the strap 11 to move through rotation of the driving gear 12. When the driving gear 12 is in mesh fit with the rack portion 111, the strap 11 will move along an extending direction of the rack portion 111 on the strap 11 with respect to the driving gear 12.

The knob assembly 20 includes a knob 21 and a self-locking mechanism 22. The self-locking mechanism 22 cooperates with the knob 21 to limit rotation direction of the knob 21, and the knob 21 is switchable between a fitting position and a release position with respect to the strap assembly 10. When the knob 21 is at the fitting position relative to the strap assembly 10, the knob 21 is in transmission fit with the driving gear 12, to actuate the driving gear 12 to rotate through the rotation of the knob 21, thereby enabling movement of the strap 11; when the knob 21 is at the release position relative to the strap assembly 10, the knob 21 is unmated from the driving gear 12 and could not actuate the driving gear 12 to rotate, and the driving gear is enabled to rotate through the mesh between the rack portion 111 and the driving gear 12 when the strap is pulled. Wherein in case that the knob 21 is at the release position relative to the strap assembly 10, the knob 21 is unmated from the driving gear 12. At this moment, a user may manually drive the strap assembly 10 to adjust its length.

When the knob 21 is in transmission fit with the driving gear 12, the rotation of the driving gear 12 may be actuated by driving the knob 21 to rotate; the driving gear 12 is in mesh fit with the rack portion 111 to drive movement of the strap 11 through the rotation of the driving gear 12; when the knob 21 is unmated from the driving gear 12, the mesh fit between the driving gear 12 and the rack portion 111 is no longer affected by the knob assembly 20. In other words, the self-locking mechanism 22 will not limit the rotation of the driving gear 12 relative to the rack portion 111. The user may quickly adjust the strap assembly 10 in a manual way.

It is to be understood that the rotation direction of the knob 21 may be limited by the fitting between the self-locking mechanism and the knob 21. As a result, when the knob 21 is in transmission fit with the driving gear 12, the driving gear 12 can only rotate unidirectionally. After the strap adjustment apparatus 100 is adjusted to be fitted with the head size of the wearer, the loosening problem of the strap assembly 10 is avoided and the wearing effects of the strap adjustment apparatus 100 are guaranteed. Wherein in the case that the knob 21 is in transmission fit with the driving gear 12, the driving gear 12 rotates unidirectionally to fasten the strap 11. Besides, the rotation direction of the driving gear 12 is limited by the self-locking mechanism during the adjustment, to avoid loosening of the strap 11 resulted from reverse rotation of the driving gear 12.

It is to be explained that the switching of the strap assembly 10 between the fitting position and the release position is implemented by driving the knob 21. The knob 21 may be driven by operation actions on a switch of the knob 21, including pushing, pulling and turning.

The elastic reset element 30 and the knob 21 are linked mutually. The elastic reset element 30 may switch between a compressed state and a reset state by a linkage fit with the knob 21. When the knob 21 moves to the release position, it links with the elastic reset element 30 to compress and deform the elastic reset element 30 to the compressed state; as the elastic reset element 30 restores from the deformation to the reset state, it links with the knob 21 to actuate the knob 21 to move to the fitting position.

While switching from the reset state to the compressed state, the elastic reset element 30 accumulates energy progressively. When it is required to reset the knob 21, the elastic reset element 30 may release the energy and drive the knob 21 to move to the fitting position, to realize reset of the knob 21. It is to be noted that the knob 21 may be pushed between the fitting position and the release position and the user may adjust the position of the knob 21 by pushing it. For example, the user may adjust the knob 21 to the fitting position by pushing it, and the user also may adjust the knob 21 to the release position by pushing it. In other words, the pushable knob 21 is used to adjust its position state. In view of the design requirements, the knob assembly 20 may be such constructed that the knob 21 is adjusted to the fitting position by pushing it. Alternatively, in accordance with further design needs, the knob assembly 20 may be constructed to adjust the knob 21 to the release position by pushing it.

The strap adjustment apparatus 100 in accordance with embodiments of the present disclosure may drive the strap 11 to move through the transmission fit between the knob assembly 20 and the driving gear 12, to adjust the fitting position between the driving gear 12 and the strap 11. Accordingly, the length of the strap assembly 10 is adjusted, to fit the strap adjustment apparatus 100 with the wearer. In the process of adjustment, the position of the knob 21 is adjusted by a linkage action between the elastic reset element 30 and the knob 21, to satisfy the needs of the user for fastening or releasing the strap assembly 10. This adjustment method is simple and highly reliable.

In some embodiments of the present disclosure, the knob 21 includes a knob body 211 and a knob shaft 212. One of the knob shaft 212 and the driving gear includes a gear shaft section 2121, and the other includes a ring gear bore 121. Wherein when the gear shaft section 2121 is formed on the knob shaft 212, the ring gear bore 121 is formed on the driving gear 12.

On an outer circumferential surface of the gear shaft section 2121, there is arranged a first mesh tooth 2121a; and on an inner bore surface of the ring gear bore 121, there is arranged a second mesh tooth 121a. The elastic reset element 30 is restored from deformation to insert the gear shaft section into the ring gear bore 121. In case that the gear shaft section 2121 is in insertion fit with the ring gear bore 121, the first mesh tooth 2121a and the second mesh tooth 121a are in mesh transmission. By driving the knob shaft 212 to rotate about its central axis, the ring gear bore 121 may be actuated to rotate synchronously, i.e., the knob 21 and the driving gear 12 may rotate in synchronization. It is to be appreciated that in case that the first mesh tooth 2121a is formed on an outer circumferential surface of the gear shaft section 2121 and the second mesh tooth 121a is formed on an inner bore surface of the ring gear bore 121, the first mesh tooth 2121a and the second mesh tooth 121a are in mesh fit to form a spline structure, to ensure the stability when the knob 21 actuates the driving gear 12 to rotate.

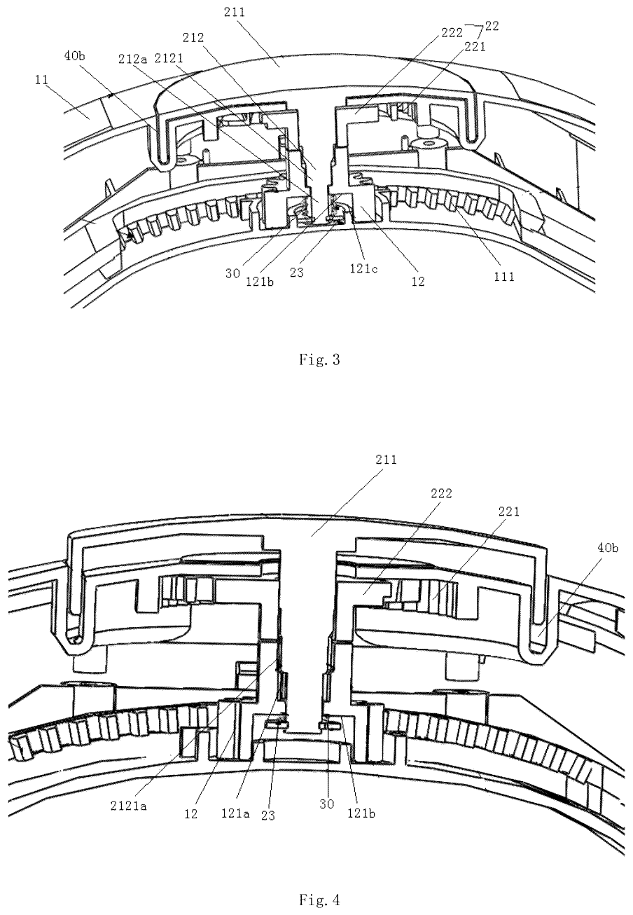

As shown in FIG. 3, in the embodiments of the present disclosure, the ring gear bore 121 is disposed on the driving gear 12. Besides, the driving gear 12 also includes a mounting hole 121c located on a side of the ring gear bore 121 away from the knob body 211. A sidewall of the mounting hole 121c close to the ring gear bore 121 is a stop wall 121b. On the stop wall 121b, a via is arranged for connecting the ring gear bore 121 with the mounting hole 121c. The gear shaft section 2121 is arranged on the knob shaft 212. The knob shaft 212 also includes a mounting section 212a, which is connected at a side of the gear shaft section 2121 away from the knob body 211. The mounting section 212a penetrates through the via. A stopper 23 is arranged on a part of the mounting section 212a within the mounting hole 121c. The elastic reset element 30 is sandwiched between the stopper 23 and the stop wall 121b.

With reference to FIGS. 3 and 4, the elastic reset element 30 is sandwiched between the stopper 23 and the stop wall 121b. In case that the position of the stopper 23 changes relative to the stop wall 121b, the elastic reset element 30 may be compressed. The elastic reset element 30 accumulates energy while being compressed and may drive the stopper 23 to reset by releasing the energy, i.e., the stopper 23 is driven to move towards a side away from the stop wall 121b.

According to FIGS. 3 and 4, the knob 21 may move axially with respect to the driving gear 12, and the stopper 23 is disposed at an end of the mounting section 212a. The elastic reset element 30 is sandwiched between the stopper 23 and the stop wall 121b. Wherein the first mesh tooth 2121a is engaged with the second mesh tooth 121a in FIG. 3, and the first mesh tooth 2121a is disengaged from the second mesh tooth 121a in FIG. 4. When the knob shaft 212 moves along the axial direction of the driving gear 12 towards a side to take off from the driving gear 12 (i.e., upward direction in the drawings), the stopper 23 moves in synchronization with the knob 21 along the axial direction and towards a side close to the stop wall 121b. While the stopper 23 is moving, the elastic reset element 30 is compressed. In case that the knob 21 is not actuated towards a side to take off from the driving gear 12, the stopper 23 may be driven to move towards a side away from the stop wall 121b under the action of the elastic reset element 30, to restore the knob assembly 20. Therefore, the switching of the knob 21 between the release position and the fitting position is implemented.

In some embodiments of the present disclosure, the stopper 23 is constructed as a jump ring. The jump ring plays a limiting role in the axial direction and mates with the stop wall 121b to limit the elastic reset element 30.

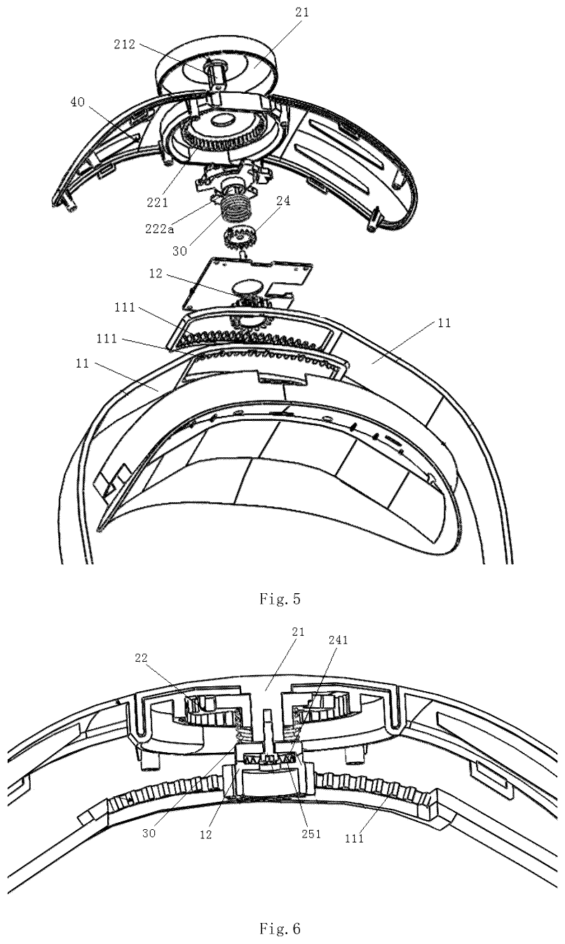

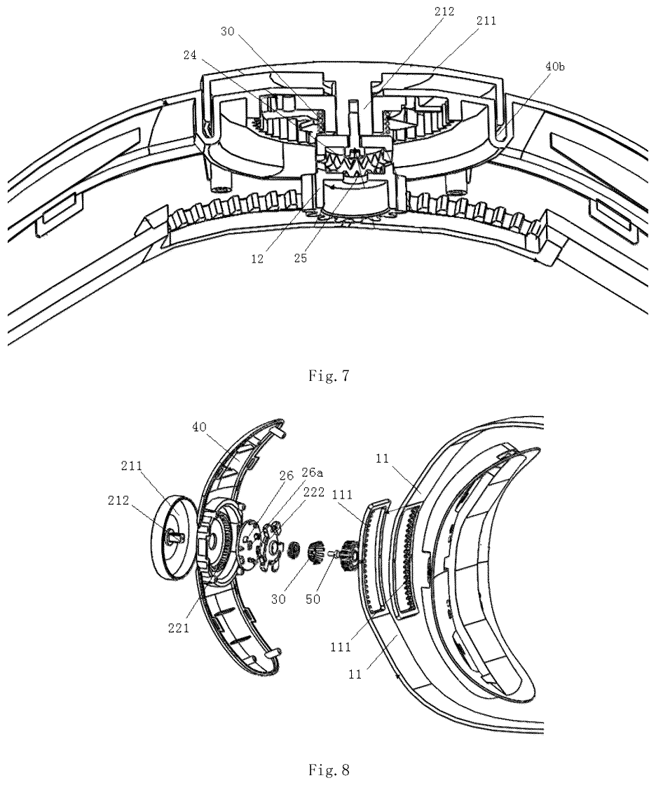

As shown in FIGS. 6 and 7, in some embodiments of the present disclosure, a first toothed disc 24 is arranged on a side of the knob 21 close to the driving gear 12 and a second toothed disc 25 is arranged on a side of the driving gear 12 close to the knob 12. The first toothed disc 24 and the second toothed disc 25 are arranged opposite to each other. A first engagement tooth 241 is formed on a lateral end face of the first toothed disc 24 facing the second toothed disc 25, and a second engagement tooth 251 is formed on a lateral end face of the second toothed disc 25 facing the first toothed disc 24. The elastic reset element 30 drives the engagement between the first toothed disc 24 and the second toothed disc 25 through restoring from the deformation, to cause engagement transmission between the first engagement tooth 241 and the second engagement tooth 251.

When the elastic reset element 30 is in the reset state, the knob assembly 20 is at the fitting position where it is in transmission fit with the driving gear 12. At this moment, the first engagement tooth 241 and the second engagement tooth 251 are engaged. While maintaining the engaged state, the first toothed disc 24 and the second toothed disc 25 may rotate about the central axis synchronously, i.e., the knob 21 may deliver the driving force to the second toothed disc 25 through the first toothed disc 24. As the second toothed disc 25 is disposed on the driving gear 12, the knob 21 may actuate the driving gear 12 to rotate.

Wherein when the elastic reset element 30 is in the compressed state, the knob assembly 20 is at the release position where it detaches from the driving gear 12. By now, the first engagement tooth 241 is separated from the second engagement tooth 251 (i.e., no engagement therebetween) and the drive between the knob 21 and the driving gear 12 could not be realized. That is, it is impossible to actuate the driving gear 12 to rotate through rotating the knob 21.

Accordingly, the strap adjustment apparatus 100 of the above first embodiment may manually actuate the knob 21 to move towards a side away from the driving gear 12, to relieve the knob 21 from the transmission fit with the driving gear 12. When the knob assembly 20 is adjusted from the fitting position to the release position, the stopper 23 and the stop wall 121b move close to each other to compress the elastic reset element 30, and the elastic reset element 30 further accumulates energy. If the users stop applying a drive force on the knob 21 to move it away, the elastic reset element 30 releases the energy to actuate the stopper 23 to be away from the stop wall 121b. The stopper 23 may drive the knob body 211 to move in synchronization, so as to adjust the knob assembly 20 from the release position to the fitting position. At this moment, the rotation of the driving gear 12 may be actuated by rotating the knob 21.

As shown in FIGS. 6 and 7, in the embodiments of the present disclosure, the knob 21 includes a knob body 211 and a knob shaft 212, where the knob body 211 is located at an outer side of the self-locking mechanism 22; the first toothed disc 24 is positioned at an inner side of the self-locking mechanism 22; and the knob shaft 212 penetrates through the self-locking mechanism 22. Moreover, the knob shaft 212 is connected to the knob body 211 at one end and to the first toothed disc 24 at the other. The elastic reset element 30 is sandwiched between the self-locking mechanism 22 and the first toothed disc 24. It is to be explained that “the other end” of the knob shaft 212 refers to an end of the knob shaft 212 close to the driving gear 12 and “one end” of the knob shaft 212 indicates an end of the knob shaft 212 away from the driving gear 12.

The knob body 211 is connected with a rotation shaft. As the knob body 211 is driven to rotate, the knob shaft 212 may rotate synchronously with the knob body 211. The first toothed disc 24 is positioned at an inner side of the self-locking mechanism 22 and the elastic reset element 30 is propped between the first toothed disc 24 and the self-locking mechanism 22. When the knob 21 is driven to move towards the outside (i.e., away from the driving gear 12), the first toothed disc 24 moves in synchronization with the knob shaft 212 and the position of the self-locking mechanism 22 remains unchanged. The first toothed disc 24 and the self-locking mechanism 22, like two opposite end faces, may compress the elastic reset element 30. Wherein when the first toothed disc 24 moves towards a side close to the self-locking mechanism 22, the first toothed disc 24 is separated from the second toothed disc 25, i.e., the first engagement tooth 241 and the second engagement tooth 251 are relieved from the engaged state. At this moment, the knob assembly 20 is no longer in transmission fit with the strap assembly 20 and the strap assembly 10 may quickly adjust the fitting position for the strap 11 and the driving gear 12 in a manual way.

In case that a drive force is not applied to the knob 21 to move away from the driving gear 12 and the knob 21 is at the release position, the elastic reset element 30 may drive the first toothed disc 24 to move towards the second toothed disc 25, such that the first toothed disc 24 and the second toothed disc 25 are in transmission fit to adjust the knob 21 to the fitting position through the elastic reset element.

As shown in FIG. 5, in some embodiments of the present disclosure, the first toothed disc 24 and the knob shaft 212 are discrete components and assembled together, and the second toothed disc 25 and the driving gear 12 are integrated. The knob assembly 20 also includes a threaded connector adapted to penetrate through the first toothed disc 24 and fixate the first toothed disc 24 to the knob shaft 212. The first toothed disc 24 is connected with the knob shaft 212 in a simple and more reliable way. Meanwhile, the threading connection via the threaded connector may reduce the space occupied by the components and enhance the compactness of the structure of the knob assembly 20.

The knob shaft 212 is constructed in a hollow shaft structure and inner threads are formed in a hollow portion of the knob shaft 212. The threaded connector penetrates through the first toothed disc 24 and mates with the inner threads, to fixedly connect the first toothed disc 24 with the knob shaft 212. Wherein in case that the first toothed disc 24 is securely connected with the knob shaft 212, they are disposed concentrically. In other words, the central axis of the first toothed disc 24 is collinear with the central axis of the knob shaft 212, to ensure rotational stability of the first toothed disc 24.

Accordingly, the strap adjustment apparatus 100 of the above second embodiment may manually actuate the knob 21 to move away from the driving gear 12, to relieve the knob 21 from the transmission fit with the driving gear 12. When the knob assembly 20 is adjusted from the fitting position to the release position, the first toothed disc 24 and the self-locking mechanism 22 cooperate to compress the elastic reset element 30, and the elastic reset element 30 further accumulates energy. If the users stop applying a drive force on the knob 21 to move it away, the elastic reset element 30 releases the energy to actuate the first toothed disc 24 to move toward the second toothed disc 25. The first toothed disc 24 may drive the knob body 211 to move in synchronization, so as to adjust the knob assembly 20 from the release position to the fitting position. At this moment, the rotation of the driving gear 12 may be actuated by rotating the knob 21.

In some embodiments of the present disclosure, the driving gear 12 is arranged thereon with a plurality of first mating portions 122 disposed around an axis of the driving gear 12. The elastic reset element 30 includes a plurality of second mating portions 31. By restoring from deformation, the elastic reset element 30 enables a plurality of second mating portions 31 to cooperate with a plurality of first mating portions 122 one-on-one, such that the knob 21 actuates the driving gear 12 to rotate via the elastic reset element 30.

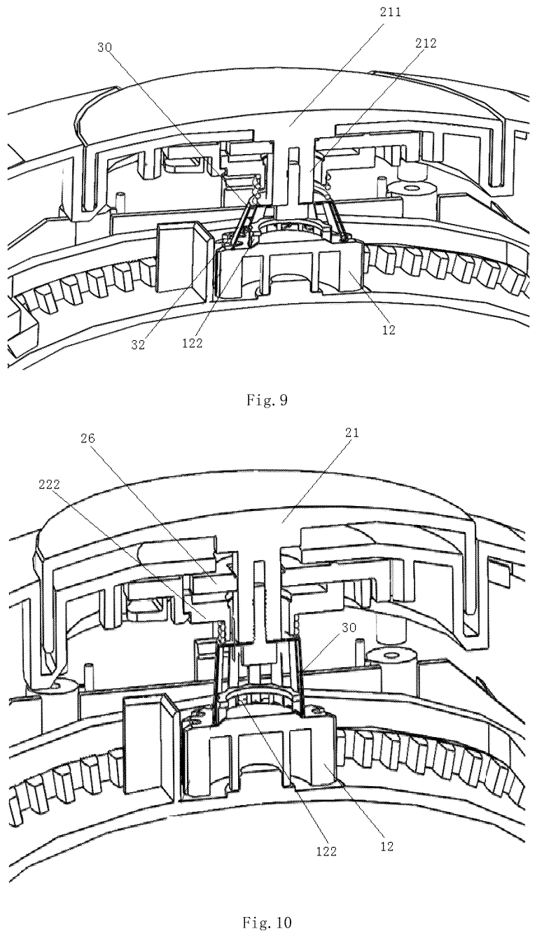

With reference to FIG. 8, FIG. 9, and FIG. 10, the knob assembly 20 is connected to the elastic reset element 30, so as to be selectively in transmission fit with the driving gear 12 through the elastic reset element 30. When a plurality of second mating portions 31 cooperates with a plurality of first mating portions 122 one by one, the driving gear 12 is in transmission fit with the elastic reset element 30. The elastic reset element 30 is driven to actuate the driving gear 12 to move in synchronization, i.e., in case that the knob 21 is driven to rotate, the elastic reset element 30 rotates in synchronization with the knob assembly 20. Besides, on account of the transmission fit between the elastic reset element 30 and the driving gear 12, the driving gear 12 also may rotate synchronously with the knob assembly 20 to adjust the strap assembly 10.

As shown in FIGS. 9-10, in the embodiments of the present disclosure, the driving gear 12 includes a gear portion 123 and a protruding portion 124. The gear portion 123 mates with the rack portion 111; the protruding portion 124 is disposed on a side of the gear portion 123 close to the knob 21; and a plurality of first mating portions 122 is formed on an outer circumferential surface of the protruding portion 124. Wherein the protruding portion 124 protrudes from an axial end face of the gear portion 123 towards one side of the knob 21 along the axial direction and is disposed around a circumferential direction of the protruding portion 124 (i.e., around a central axis direction of the gear portion 123).

With reference to FIGS. 9 and 10, the elastic reset element 30 is mounted on the knob 21 and includes a plurality of leg portions 32. A free end 32b of the leg portion 32 extends to a axial end face of the gear portion 123 on a side close to the protruding portion 124. The free ends 32 of a plurality of leg portions 32 are disposed around the protruding portion 124. The second mating portion 31 is arranged at the free end 32b of the leg portion 32. By compression deformation, the elastic reset element 30 scatters a plurality of leg portions 32 to unmate a plurality of first mating portions 122 from a plurality of second mating portions 31. Wherein the state of the elastic reset element 30 may be adjusted by driving the knob 21. For example, the elastic reset element 30 may be compressed by pushing the knob 21.

According to FIGS. 9 and 10, the leg portions 32 of the elastic reset element 30 may swing relative to a fixed end 32a, to enable the free end 32b to move towards or away from the second mating portions 31. When a drive force of the knob assembly 20 is delivered to the elastic reset element 30, the elastic reset element 30 may be compressed. In FIG. 9, the elastic reset element 30 is in the compressed state; the first mating portion 122 is separated from the second mating portion 31; and the elastic reset element 30 is separated from the driving gear 12; by now, the strap assembly 10 may be adjusted freely. In FIG. 10, the elastic reset element 30 is in the reset state; the first mating portion 122 cooperates with the second mating portion 31; and the elastic reset element 30 is in transmission fit with the driving gear 12. By now, the elastic reset element 30 may be driven by the knob assembly 20 to actuate the driving gear 12 to rotate. It is to be understood that when a plurality of first mating portions 122 cooperates with a plurality of second mating portions 31, the elastic reset element 30 is locked with the driving gear 12 in the circumferential direction; in case that the knob assembly 20 drives the elastic reset element 30 to rotate, the elastic reset element 30 may actuate the driving gear 12 to rotate synchronously

In some embodiments of the present disclosure, the second mating portion 31 is formed into a pin, which is resulted by blending the free end 32b of the leg portion 32 in a direction towards the protruding portion 124. The first mating portion 122 is formed into a slot arranged on an outer circumferential surface of the protruding portion 124. The high reliability of the pin-slot fit may ensure the mating reliability between the first mating portion 122 and the second mating portion 31.

Referring to FIGS. 9 and 10, when the pin is in insertion fit with the slot, the pin may limit the elastic reset element 30 and the driving gear 12 in the axial direction, to prevent the pin from slipping out from the slot. Besides, when a plurality of pins is in insertion fit with a plurality of slots, the elastic reset element 30 and the driving gear 12 may be limited in the circumferential direction, to ensure the transmission effects between the elastic reset element 30 and the driving gear 12.

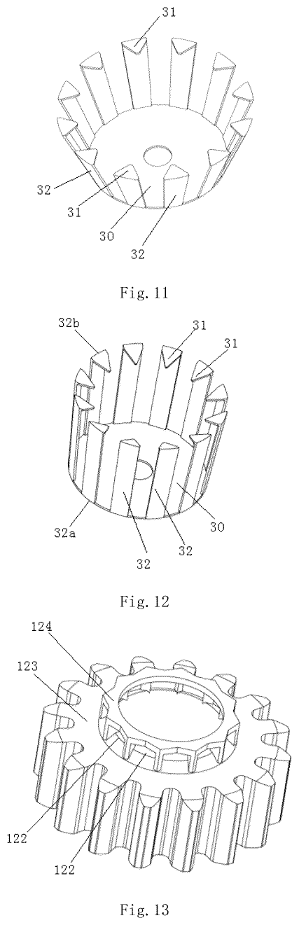

According to FIGS. 11 and 12, the pin is constructed in such a shape that gradually expands from an end away from the leg portion 32 to an end connected to the leg portion 32, to facilitate the insertion fit between the pin and the slot.

As shown in FIG. 8, in some embodiments of the present disclosure, the elastic reset element 30 and the knob 21 are discrete components; and the elastic rest element 30 is an integrated piece and includes a connection portion connecting to each of a plurality of leg portions 32. The connection portion is connected with the knob 21 via a connector 50.

According to FIGS. 9 and 10, the connection portion is abutted against the knob shaft 212. The connector 50 passes through the connection portion and is fixedly connected to the knob shaft 212, to securely connect the elastic reset element 30 with the knob shaft 212. The fitting between the elastic reset element 30 and the knob 21 is simple and highly reliable. After the elastic reset element 30 is fixedly connected to the knob shaft 212, the elastic reset 30 may synchronously rotate with the knob 21.

Accordingly, the strap adjustment apparatus 100 of the above third embodiment may manually drive the knob 21 to move towards one side close to the driving gear 12, i.e., the elastic reset element 30 is relieved from the transmission fit with the driving gear 12 by pushing the knob 21; besides, while the knob 21 is being pushed, the knob shaft 212 cooperates with the end face of the gear portion 123 to compress the elastic reset element 30 and the elastic reset element 30 accumulates energy. When the users stop pushing the knob 21, the elastic reset element 30 releases the energy to drive the knob shaft 212 to move away from the driving gear 12. In the reset process of the elastic reset element 30, the first mating portion 122 is again in the insertion fit with the second mating portion 31. At this time, the elastic reset element 30 is in transmission fit with the driving gear 12, to actuate the driving gear 12 to rotate by turning the knob 21.

As shown in FIGS. 2, 5 and 8, in some embodiments of the present disclosure, the strap adjustment apparatus 100 includes a mounting case 40 on which a perforation 40a is arranged. The knob 21 includes the knob body 211 positioned at an outer side of the mounting case 40 and the knob shaft 212 that penetrates through the perforation 40a. Further, one end of the knob shaft 212 is connected to the knob body 211 and the other end of the knob shaft 212 is disposed at the inner side of the mounting case 40. Wherein the mounting case 40 is a mounting carrier for the strap assembly 10 and the knob assembly 20. The mounting case 40 may be a good shelter for the strap assembly 10 and the knob assembly 20 and also protect them well. Meanwhile, the appearance of the strap adjustment apparatus 100 also can be improved.

Both the self-locking mechanism 22 and the strap assembly 10 are located at the inner side of the mounting case 40. The knob 21 cooperates with the driving gear 12 and the self-locking mechanism 22 via the knob shaft 212, wherein the self-locking mechanism 22 is fixed relative to the position of the strap assembly 10. The transmission fit between the knob assembly 20 and the strap assembly 10 may be adjusted by pushing or pulling the knob 21.

In some embodiments of the present disclosure, the self-locking mechanism 22 is supported and fixated via a mounting bracket (not shown). The mounting bracket is fixedly connected to the strap assembly 10 and may support and secure the self-locking mechanism 22 without requiring the arrangement of the mounting case 40.

In some further embodiments of the present disclosure, the mounting case 40 may be integrated with the self-locking mechanism 22.

In some embodiments of the present disclosure, a sinking groove 40b is arranged on the outer surface of the mounting case 40 and the perforation 40a is formed on a bottom wall of the sinking groove 40b. At one of the fitting position and the release position, the knob body 211 is received in the sinking groove 40b. At the other of the fitting position and the release position, the knob body 211 projects from the sinking groove 40b.

In some embodiments of the present disclosure, the mounting case 40 includes a first housing and a second housing, which are fixedly connected to form the mounting case 40. Wherein the first housing and the second housing are formed with opposing mounting chambers. The strap assembly 10, the elastic reset element 30 and the knob assembly 20 are all mounted in the mounting case 40. Through a split-type design of the mounting case 40, the difficulty for assembling the knob assembly 20 and the strap assembly 10 may be lowered and the assembly efficiency is thus improved.

With reference to FIGS. 3, 4, 6 and 7, in the strap adjustment apparatus 100 of the first and second embodiments, when the knob 21 is at the fitting position, the knob body 211 is received in the sinking groove 40b. The knob body 211 is rotated to drive the rotation of the driving gear 12, so as to adjust the strap assembly 10. When the knob 21 is at the release position, the knob body 211 projects from the sinking groove 40b. At this time, it is impossible to adjust the strap assembly 10 through driving the knob 21. However, the strap assembly 10 may be adjusted by a manual drive.

According to FIGS. 9 and 10, in the strap adjustment apparatus 100 of the third embodiment, when the knob 21 is at the fitting position, the knob body 211 projects from the sinking groove 40b. The knob body 211 may be rotated to drive the rotation of the driving gear 12, so as to adjust the strap assembly 10. When the knob 21 is at the release position, the knob body 211 is received in the sinking groove 40b. At this time, it is impossible to adjust the strap assembly 10 through driving the knob 21. However, the strap assembly 10 may be adjusted by a manual drive.

Wherein the user may adjust the knob 21 from the fitting position to the release position by turning the knob body 211, and the knob 21 may be adjusted from the release position to the fitting position under the action of the elastic reset element 30.

In some embodiments of the present disclosure, the knob body 211 is arranged to project from the outer surface of the mounting case 40, i.e., no sinking groove 40b is arranged in the mounting case 40. In a process of adjusting the position of the knob body 211 relative to the mounting case 40, the knob body 211 is constantly projecting from the outer surface of the mounting case 40, but the height of the knob body 211 projecting from the outer surface of the mounting case may differ from the fitting position to the release position.

In some embodiments of the present disclosure, the sidewall of the sinking groove 40b has at least one notch. On an axial projection of the driving gear 12, the knob body 211 at least partly projects from the notch. The users may control the knob 21 at the notch to rotate or turn the knob 21. It is to be appreciated that the notch may avoid at least part of the knob body 211 to facilitate the fitting with the knob body 211 and further actuate the knob 21 to move.

In some embodiments of the present disclosure, a friction part is disposed on the outer circumferential surface of the knob body 211. The friction part may cooperate with the hand of the user to increase a friction force between the hand and the outer circumference of the knob body 211, so as to make it easy for users to turn the knob body 211.

In some further embodiments of the present disclosure, a hand part is disposed on the outer circumferential surface of the knob body 211. Via the hand part, the users may drive the knob body 211 to move to promote usage experience of the user. Wherein the hand part may be constructed as, but not limited to, a protruding, a stereo cartoon structure or a handle. The purpose is to facilitate the user to hold the knob by hand to drive the knob body 211 to move.

According to FIGS. 2 and 3, in some embodiments of the present disclosure, the self-locking mechanism 22 includes: a ratchet ring 221 and a pawl disc 222 fitted in the ratchet ring 221. The ratchet ring 221 is disposed on the mounting case 40 and the knob shaft 212 cooperates with the pawl disc 222 to rotate synchronously. Wherein the ratchet ring 221 mates with the pawl disc 222 in a rotatable way and has a good limiting effect on the rotation direction of the pawl disc 222. That is, the pawl disc 222 can only rotate along the same direction (clockwise or counterclockwise direction) with respect to the ratchet ring 221. Since the knob shaft 212 cooperates with the pawl disc 222 to implement synchronous movement, the ratchet ring 221 also may limit the rotation direction of the knob 21, to fulfill self-locking of the knob assembly 20.

In the embodiments of the present disclosure, the pawl disc 222 is arranged thereon with a first fitting hole 222a, through which the knob shaft 212 is inserted. The knob shaft 212 and the first fitting hole 222a form a non-circular surface transmission fit. Wherein the knob shaft 212 penetrates through the first fitting hole 222a and a sectional shape and size of the knob shaft 212 is adapted to the size and shape of the first fitting hole 222a, to ensure the effects of the transmission fit between the knob shaft 212 and the pawl disc 222. As a result, the knob shaft 212 and the pawl disc 222 synchronously rotate about the central axis of the knob shaft 212. It is to be explained that the first fitting hole 222a is constructed as a non-circular hole. If the first fitting hole 222a is constructed in a circular shape, the knob shaft 212 and the first fitting hole 222a could not rotate in synchronization merely through the insertion fit.

In some embodiments of the present disclosure, the knob assembly 20 also includes a transmission component 26 on which a second fitting hole 26a is arranged. The knob shaft 212 is inserted into the second fitting hole 26a and the knob shaft 212 and the second fitting hole 26a form a non-circular surface transmission fit. The transmission component 26 cooperates with the pawl disc 222 to rotate in synchronization. Wherein the knob shaft 212 penetrates through the second fitting hole 26a and sectional shape and size of the knob shaft 212 is adapted to the size and shape of the second fitting hole 26a, to ensure the effects of the transmission fit between the knob shaft 212 and the pawl disc 222. As a result, the knob shaft 212 and the drive 26 synchronously rotate about the central axis of the knob shaft 212.

The knob 21 is in transmission fit with the pawl disc 222 through the transmission component 26. In other words, when the knob 21 actuates the transmission component 26 to rotate, the transmission component 26 cooperates with the pawl disc 222 to implement synchronous rotation of the knob 21, the transmission component 26 and the pawl disc 222.

In some embodiments of the present disclosure, the transmission component 26 is disposed on a side of the pawl disc 222 close to the knob body 221 in the axial direction. A protrusion is arranged on one of the transmission component 26 and the pawl disc 222 and a recess is arranged on the other. The protrusion and the recess are mated to form a transmission unit. There are multiple transmission units eccentrically disposed with respect to the rotational axis of the pawl disc 222.

In case that the transmission component 26 has a protrusion, the pawl disc 222 is arranged with a recess; when the transmission component 26 has a recess, the pawl disc 222 is arranged with a protrusion. It is certain that the transmission component 26 may be arranged with both a protrusion and a recess simultaneously. Correspondingly, positions on the pawl disc 222 corresponding to the protrusion and recess in the transmission component 26 are also arranged with a recess and a protrusion. Through the fitting between the protrusion and the recess, the transmission component 26 and the pawl disc 222 constitute the transmission unit, i.e., the transmission component 26 and the pawl disc 222 may synchronously rotate about the rotational axis.

It is to be understood that for transmission stability among the knob 21, the transmission component 26 and the pawl disc 222, the rotational axis is disposed at the center position of the transmission component 26 and the pawl disc 222. The center axis of the knob shaft 212 is the rotational axis, and the protrusion and the recess are disposed eccentrically to avoid the knob shaft 212.

As shown in FIG. 2, in some embodiments of the present disclosure, the strap assembly 10 includes two straps 11, each of which is arranged with a slide groove 11a. The ends of the two straps are stacked, such that the two slide grooves 11a have an overlapping area in which the driving gear 12 is disposed. The rack portion 111 is arranged at a width side of the slide groove 11a and the rack portions 111 of the two straps 11 are respectively located at both sides of the driving gear 12, to actuate the two straps 11 to move reversely through the rotation of the driving gear 12.

Wherein “move reversely” indicates that the straps 11 move towards each other and move away from each other. When the straps 11 are moving towards each other, the strap assembly 10 may close tight around the head of the wearer; in case that the straps 11 are moving away from each other, the strap assembly 10 may be loosened to separate the strap adjustment apparatus 100 from the head of the user.

Since the two straps are both arranged with the rack portion 111, the driving gear 12 may be meshed with the two rack portions 111 simultaneously, which may promote the driving effects of the driving gear 12 on the rack portion 111. That is, the stability is better when the two straps 11 move towards each other. Meanwhile, in comparison to a solution in which only one rack portion 111 is disposed, when the strap assembly 10 varies by the same length (i.e., the two straps 11 cooperate to define a length size of the strap assembly 10), the driving gear 12 is required to rotate by a smaller angle, which is only half of the solution where only one rack portion 111 is disposed. As a result, the adjustment efficiency of the strap adjustment apparatus 100 may be improved.

The head-mounted electronic device in accordance with embodiments of the present disclosure includes the above strap adjustment apparatus 100 of the head-mounted electronic device. With the arrangement of the above strap adjustment apparatus 100, the head-mounted electronic device may be easily fixed to the head of the wearer. Besides, the head-mounted electronic device may be adapted to users with different head circumferences, which promotes the universality of the head-mounted electronic device while ensuring the wearing effects of the head-mounted electronic device. Moreover, it is easy to make an adjustment through the strap adjustment apparatus 100 and the users may experience more comfort.

In the description of the present disclosure, it is to be understood that orientation or position relations indicated by terms, including “center”, “longitudinal”, “lateral”, “length”, “width”, “thickness”, “up”, “down”, “front”, “back”, “left”, “right”, “vertical”, “horizontal”, “top”, “bottom”, “inner”, “outer”, “clockwise”, “counterclockwise”, “axial”, “radial” and “circumferential” depend on the drawings. They are disclosed to describe the present disclosure in a simple way, rather than indicating or suggesting that the apparatus or element must have the specific orientation, or be constructed and operated in the specific orientation. Therefore, the above terms should not be interpreted as limitations over the present disclosure.

Besides, the terms “first” and “second” are provided merely for descriptive purpose and do not indicate or suggest relative importance or imply the quantity of the specified technical feature. Accordingly, the feature defined by “first” and “second” may explicitly or implicitly indicate one or more of this feature. In the description of the present disclosure, “a plurality of” means two or more unless clearly indicated otherwise.

In the present disclosure, unless clearly indicated and defined otherwise, the terms “mount”, “link”, “connect” and “fix” should be interpreted at a broad level. For example, it may be fixed connection, and also may be detachable connection or being integrated; it may refer to mechanical connection, or electrical connection; it may be direct connection or indirect connection via an intermediate; it may be connections within the two components or interactions between the two components. For those skilled in the art, the specific meaning of the above terms in the present disclosure depend on the situations.

In the present disclosure, unless clearly indicated and defined otherwise, when it is disclosed that the first feature is “on” or “under” the second feature, it may indicate that the first and second features make direct contact or the first and second features indirectly contact via an intermediate. Besides, if the first feature is “on”, “over” or “above” the second feature, the first feature may be directly or diagonally above the second feature; alternatively, it may only indicate that the first feature is at a higher level than the second feature. If the first feature is “below”, “under” or “underneath” the second feature, the first feature may be directly or diagonally below the second feature; alternatively, it may indicate that the first feature is at a lower level than the second feature.

In the present disclosure, the description in conjunction with the terms “one embodiment”, “some embodiments”, “example”, “specific example” or “some examples” indicate that specific features, structures, materials or characteristics described with reference to the embodiment or example are included in at least one embodiment of example of the present disclosure. In the description, the schematic representations of the terms used above are not necessarily intended for the same embodiment or example. Furthermore, the particular features, structures, materials, or characteristics described may be combined in any suitable manner in any one or more embodiments or examples. Furthermore, various embodiments or examples and features of different embodiments or examples described in this description can be combined by those skilled in the art if no conflicts are present.

Although embodiments of the present invention have been shown and described above, it is understood that the above embodiments are exemplary and should not be interpreted as limitations over the present disclosure. Those ordinary skilled in the art may change, modify, replace or alter the above embodiments within the scope of the present disclosure.

1. A strap adjustment apparatus of a head-mounted electronic device, comprising:
a strap assembly including a strap and a driving gear, wherein the strap includes a rack portion and the driving gear is in mesh with the rack portion to actuate the strap to move through rotation of the driving gear;
a knob assembly including a knob and a self-locking mechanism, wherein the self-locking mechanism cooperates with the knob to limit a rotational direction of the knob; the knob is switchable between a fitting position and a release position with respect to the strap assembly; the knob, at the fitting position, is in transmission fit with the driving gear to actuate the driving gear to rotate through rotation of the knob, thereby driving the strap to move; and the knob, at the release position, is unmated from the driving gear and could not actuate the driving gear to rotate, and the driving gear is enabled to rotate through mesh between the rack portion and the driving gear when the strap is pulled; and
an elastic reset element being mutually linked to the knob to switch between a compressed state and a reset state; wherein when moving to the release position, the knob links to the elastic reset element to compress and deform the elastic reset element to the compressed state; when the elastic reset element is restored from deformation to the reset state, the knob is linked to move to the fitting position.

2. The strap adjustment apparatus of a head-mounted electronic device of claim 1, wherein the knob includes a knob body and a knob shaft; one of the knob shaft and the driving gear includes a gear shaft section, and the other includes a ring gear bore; a first mesh tooth is arranged on an outer circumferential surface of the gear shaft section, and a second mesh tooth is arranged on an inner bore surface of the ring gear bore; and the elastic reset element drives insertion of the gear shaft section into the ring gear bore by restoring from the deformation, such that the first mesh tooth is in mesh transmission with the second mesh tooth.

3. The strap adjustment apparatus of a head-mounted electronic device of claim 2, wherein the ring gear bore is disposed on the driving gear and the driving gear also includes a mounting hole located on a side of the ring gear bore away from the knob body; a sidewall of the mounting hole close to the ring gear bore is a stop wall; and a via is provided on the stop wall for connecting the ring gear bore with the mounting hole;
the gear shaft section is disposed on the knob shaft and the knob shaft also includes a mounting section being connected on a side of the gear shaft section away from the knob body; the mounting section penetrates through the via and a stopper is provided on a part of the mounting section within the mounting hole; and the elastic reset element is sandwiched between the stopper and the stop wall.

4. The strap adjustment apparatus of a head-mounted electronic device of claim 1, wherein a first toothed disc is arranged on a side of the knob close to the driving gear and a second toothed disc is arranged on a side of the driving gear close to the knob; the first toothed disc and the second toothed disc are arranged opposite to each other; a first engagement tooth is formed on a lateral end face of the first toothed disc facing the second toothed disc, and a second engagement tooth is formed on a lateral end face of the second toothed disc facing the first toothed disc; the elastic reset element drives engagement between the first toothed disc and the second toothed disc through restoring from the deformation, to cause engagement transmission between the first engagement tooth and the second engagement tooth.

5. The strap adjustment apparatus of a head-mounted electronic device of claim 4, wherein
the knob includes a knob body and a knob shaft, where the knob body is located at an outer side of the self-locking mechanism; the first toothed disc is positioned at an inner side of the self-locking mechanism; and the knob shaft penetrates through the self-locking mechanism;
and one end of the knob shaft is connected to the knob body and the other end of the knob shaft is connected to the first toothed disc; and the elastic reset element is sandwiched between the self-locking mechanism and the first toothed disc.

6. The strap adjustment apparatus of a head-mounted electronic device of claim 5, wherein the first toothed disc and the knob shaft are discrete components and assembled together, and the second toothed disc and the driving gear are integrated.

7. The strap adjustment apparatus of a head-mounted electronic device of claim 1, wherein,
the driving gear is arranged thereon with a plurality of first mating portions disposed around an axis of the driving gear; the elastic reset element includes a plurality of second mating portions; by restoring from the deformation, the elastic reset element enables a plurality of second mating portions to cooperate with a plurality of first mating portions one-on-one, such that the knob actuates the driving gear to rotate via the elastic reset element.

8. The strap adjustment apparatus of a head-mounted electronic device of claim 7, wherein the driving gear includes a gear portion and a protruding portion; the gear portion mates with the rack portion; the protruding portion is disposed on a side of the gear portion close to the knob; and the plurality of first mating portions is formed on an outer circumferential surface of the protruding portion;
the elastic reset element is mounted on the knob and includes a plurality of leg portions; free ends of the leg portions extend to a axial end face of the gear portion on a side close to the protruding portion; free ends of the plurality of leg portions are disposed around the protruding portion; the second mating portion is disposed at free ends of the leg portions; by compression deformation, the elastic reset element scatters the plurality of leg portions to unmate the plurality of first mating portions from the plurality of second mating portions.

9. The strap adjustment apparatus of a head-mounted electronic device of claim 8, wherein the second mating portion is formed into a pin, which is resulted by bending a free end of the leg portion in a direction towards the protruding portion; and the first mating portion is formed into a slot arranged on an outer circumferential surface of the protruding portion.

10. The strap adjustment apparatus of a head-mounted electronic device of claim 8, wherein the elastic reset element and the knob are discrete components; and the elastic rest element is an integrated piece and includes a connection portion connecting to each of the plurality of leg portions, the connection portion being connected with the knob via a connector.

11. The strap adjustment apparatus of a head-mounted electronic device of claim 1, comprising:
a mounting case on which a perforation is arranged, where the knob includes a knob body located on an outer side of the mounting case and a knob shaft penetrating through the perforation, and one end of the knob shaft is connected to the knob body and the other end of the knob shaft is disposed at an inner side of the mounting case;
the self-locking mechanism and the strap assembly are both positioned at the inner side of the mounting case and the knob cooperates with the self-locking mechanism and the driving gear through the knob shaft.

12. The strap adjustment apparatus of a head-mounted electronic device of claim 11, wherein a sinking groove is arranged on an outer surface of the mounting case and the perforation is formed on a bottom wall of the sinking groove; at one of the fitting position and the release position, the knob body is received in the sinking groove; and at the other of the fitting position and the release position, the knob body projects from the sinking groove.

13. The strap adjustment apparatus of a head-mounted electronic device of claim 12, wherein a sidewall of the sinking groove has at least one notch.

14. The strap adjustment apparatus of a head-mounted electronic device of claim 1, wherein the self-locking mechanism includes: a ratchet ring and a pawl disc fitted in the ratchet ring; and the ratchet ring is disposed on the mounting case and the knob shaft cooperates with the pawl disc to rotate synchronously.

15. The strap adjustment apparatus of a head-mounted electronic device of claim 14, wherein the pawl disc is provided thereon with a first fitting hole, into which the knob shaft is inserted; and the knob shaft and the first fitting hole form a non-circular surface transmission fit.

16. The strap adjustment apparatus of a head-mounted electronic device of claim 14, wherein the knob assembly also includes a transmission component on which a second fitting hole is arranged; the knob shaft is inserted into the second fitting hole; the knob shaft and the second fitting hole form a non-circular surface transmission fit; and the transmission component cooperates with the pawl disc to rotate in synchronization.

17. The strap adjustment apparatus of a head-mounted electronic device of claim 16, wherein the transmission component is disposed on a side of the pawl disc close to the knob body in the axial direction; a protrusion is arranged on one of the transmission component and the pawl disc and a recess is arranged on the other; and the protrusion and the recess are mated to form a transmission unit; and there are multiple transmission units eccentrically disposed with respect to a rotational axis of the pawl disc.

18. The strap adjustment apparatus of a head-mounted electronic device of claim 1, wherein the strap assembly includes two straps, each of which is provided with a slide groove; and ends of the two straps are stacked, such that two slide grooves have an overlapping area in which the driving gear is disposed; the rack portion is arranged at a width side of the slide groove and the rack portions of the two straps are respectively located at both sides of the driving gear, to actuate the two straps to move reversely through rotation of the driving gear.

19. A head-mounted electronic device, comprising the strap adjustment apparatus of a head-mounted electronic device comprising:
a strap assembly including a strap and a driving gear, wherein the strap includes a rack portion and the driving gear is in mesh with the rack portion to actuate the strap to move through rotation of the driving gear;
a knob assembly including a knob and a self-locking mechanism, wherein the self-locking mechanism cooperates with the knob to limit a rotational direction of the knob; the knob is switchable between a fitting position and a release position with respect to the strap assembly; the knob, at the fitting position, is in transmission fit with the driving gear to actuate the driving gear to rotate through rotation of the knob, thereby driving the strap to move; and the knob, at the release position, is unmated from the driving gear and could not actuate the driving gear to rotate, and the driving gear is enabled to rotate through mesh between the rack portion and the driving gear when the strap is pulled; and
an elastic reset element being mutually linked to the knob to switch between a compressed state and a reset state; wherein when moving to the release position, the knob links to the elastic reset element to compress and deform the elastic reset element to the compressed state; when the elastic reset element is restored from deformation to the reset state, the knob is linked to move to the fitting position.

20. The head-mounted electronic device of claim 19, wherein the knob includes a knob body and a knob shaft; one of the knob shaft and the driving gear includes a gear shaft section, and the other includes a ring gear bore; a first mesh tooth is arranged on an outer circumferential surface of the gear shaft section, and a second mesh tooth is arranged on an inner bore surface of the ring gear bore; and the elastic reset element drives insertion of the gear shaft section into the ring gear bore by restoring from the deformation, such that the first mesh tooth is in mesh transmission with the second mesh tooth.
